(19) United States
(12) Patent Application Publication
(10) Pub. No.: US 2013/0246926 A1
(43) Pub. Date: Sep. 19, 2013

(54) DYNAMIC CONTENT UPDATING BASED ON USER ACTIVITY

(71) Applicant: Nagarjuna R. Vemireddy, Charlotte, NC (US)

(72) Inventor: Nagarjuna R. Vemireddy, Charlotte, NC (US)

(73) Assignee: INTERNATIONAL BUSINESS MACHINES CORPORATION, Armonk, NY (US)

(21) Appl. No.: 13/418,386

(22) Filed: Mar. 13, 2012

(51) Int. Cl. G06F 3/01; G06F 15/16

(52) U.S. Cl. 715/738

(57) ABSTRACT

A software application is disclosed for updating content for presentation on a user's computer. A user's activity is monitored to determine one or more portions of the content likely to appeal to the user's interests. Techniques such as eye tracking, mouse pointer tracking, time spent on displayed area, etc., may be used to make such determinations. Information within the determined portions may be sent to another computer, such as a web server, where the information can be used to create and/or gather new content based on the information within the determined portions, which is subsequently returned to the sending computer. The content for presentation is updated based on the new content received. The new content can include displays, advertisements, video, and audio.

### FIELD OF THE INVENTION

The present invention relates generally to user interfaces and more particularly to dynamically updating content of the interfaces based on user actions.

### BACKGROUND OF THE INVENTION

Contextual advertising is a form of targeted advertising for advertisements appearing on websites or other media, such as content displayed in internet browsers. The advertisements themselves are selected and served by automated systems based on the content displayed to a user. Such a system scans the text of a website, containing one or more distinct webpages, for keywords and returns advertisements to the website, for display to the user, based on what the user is viewing. Returned advertisements may be displayed on a webpage being viewed by the user, or in a separate display window (e.g., pop-up windows). The scanning of text and displaying of advertisements typically happens when a user accesses/loads a website. Often, new advertisements are not displayed until a new webpage is loaded or the current webpage is refreshed. In some technologies, if an advertisement has not been selected in a certain amount of time, a different advertisement, also based on the content of the website, may be displayed.

### SUMMARY

Embodiments of the present invention disclose a method, computer program product, and computer system for dynamically updating content for presentation to a user of a computer, via a user interface. The method comprises the steps of a first computer identifying content for presentation, via a user interface, to a user of the computer. The method further comprises the first computer determining a portion of the content from which to base a subsequent update to the content, based on interaction of the user with the user interface. The method further comprises the first computer sending information within the determined portion of the content to a second computer. The method further comprises the computer receiving from the second computer, content related to the information within the determined portion. The method further comprises the computer updating the content for presentation based on the content related to the information within the determined portion.

### BRIEF DESCRIPTION OF THE SEVERAL VIEWS OF THE DRAWINGS

FIG. 1 illustrates a distributed data processing system according to one embodiment of the present invention.

FIG. 2 is a flowchart illustrating the operational steps of an activity monitoring program, in accordance with an embodiment of the invention.

FIG. 3 depicts the steps of a flowchart describing an updating program, in accordance with an illustrative embodiment.

FIG. 4 provides a means for determining a pertinent subset of content for presentation based on the location of a mouse pointer.

FIG. 5 provides a means for determining a pertinent subset of content for presentation based on time spent on displayed content.

FIG. 6 provides a means for determining a pertinent subset of content for presentation based on the location of a user's gaze on the display.

FIG. 7 provides a means for determining a pertinent subset of content for presentation based on words spoken or about to be spoken from the content via text-to-speech software.

FIG. 8 depicts an exemplary webpage displayed in a web browser interface of a user's computer, in accordance with an illustrative embodiment.

FIG. 9 depicts a block diagram of components of a client computer, in accordance with an illustrative embodiment.

### DETAILED DESCRIPTION

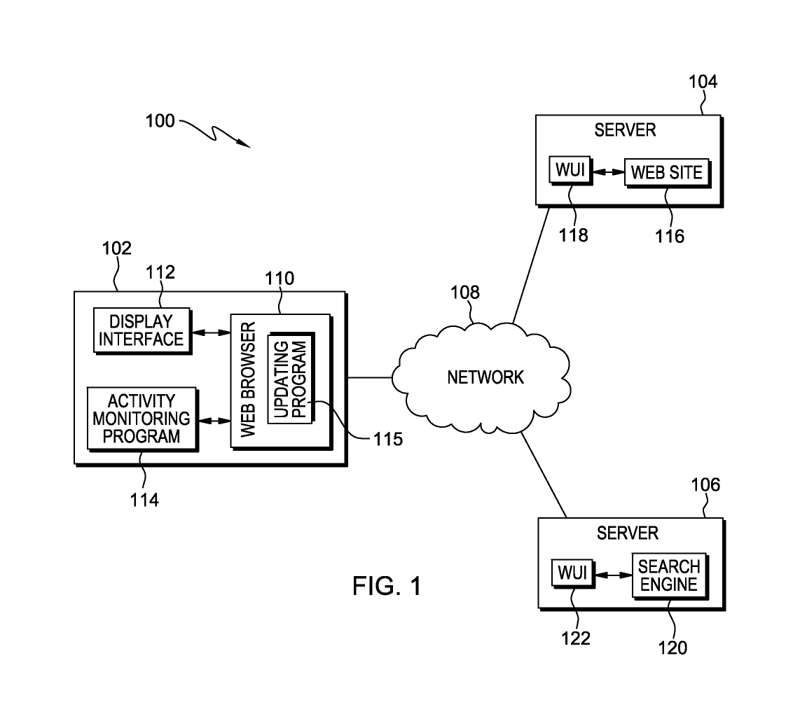

The present invention will now be described in detail with reference to the Figures. FIG. 1 illustrates a distributed data processing system, generally designated 100, according to one embodiment of the present invention.

Distributed data processing system 100 comprises client computer 102, server computer 104, and server computer 106 interconnected by network 108. Client computer 102 may be a desktop computer, a notebook computer, a laptop computer, a tablet computer, a handheld device, a smart-phone, a thin client, or any other electronic device or computing system capable of receiving input from a user, executing computer program instructions, and communicating with another computing system via network 108. Server computers 104 and 106 may be any electronic device or computing system capable of receiving and sending data to and from client computer 102 via network 108. In other embodiments, one or both of server computers 104 and 106 may represent a computing system utilizing clustered computers and components to act as a single pool of seamless resources when accessed through network 108. This is a common implementation for datacenters and for cloud computing applications.

Network 108 may include wired, wireless, or fiber optic connections. In the depicted example, network 108 is the Internet representing a worldwide collection of networks and gateways that use the Transmission Control Protocol/Internet Protocol suite of protocols to communicate with one another. Network 108 may also be implemented as a number of different types of networks, such as an intranet, a local area network (LAN), or a wide area network (WAN).

Client computer 102 includes web browser 110. A web browser is defined as application software or a program designed to enable users to access, retrieve, and view documents and other resources on a network, typically the Internet. Documents and/or resources retrieved by web browser 110 via network 108, may be viewed by a user of client computer 102 through display interface 112. A person of ordinary skill in the art will recognize that display interface 112 may in some instances be a component of web browser 110. In a preferred embodiment of the present invention, web browser 110 initiates activity monitoring program 114.

Embodiments of the present invention recognize that advertisements and other displayed content would be more pertinent to a user if based only on portions of a webpage of interest to the user as opposed to the content of the entire webpage. In one embodiment of the present invention, activity monitoring program 114 monitors actions of a user of client computer 102 to determine portions of content displayed in display interface 112 that are potentially of interest to the user. For example, if the user is looking at a specific section or paragraph of a displayed webpage, activity monitoring program 114 might determine that the user is only interested in information contained in and/or related to the specific paragraph. In response, activity monitoring program 114 returns the determined portion (or information found in the portion) to web browser 110. Web browser 110 may run updating program 115 to update the content in display interface 112 based on information in the determined portion. While the updated content is typically visual, a person of ordinary skill in the art will understand that, in some embodiments, auditory content may be added or updated.

Server computer 104 is a web server hosting website 116. Website 116 interacts with web user interface (WUI) 118. WUI 118 is a type of graphical user interface that accepts input and provides output by generating webpages, which are transmitted via network 108 and displayed to a user of client computer 102 using web browser 110. In response, web browser 110 may initiate activity monitoring program 114 to determine portions of the displayed webpage that are of interest to the user. In response, updating program 115 may request new content or an update of the displayed content (i.e., the displayed webpage). Updating program 115 may relay the user interests back to server 104, where new content, such as advertisement banners, embedded audio and/or video, etc., may be conformed to the user interests. In another embodiment, updating program 115 may request content from other server computers and receive or generate displays and/or content such as banners, pop-up windows, etc. to be displayed on top of and/or concurrently with the webpage, independently of server computer 104.

Similarly, server computer 106 depicts a web server hosting search engine 120. Search engine 120 receives search requests and displays results to a user of client computer 102 through WUI 122 communicating with web browser 110. Activity monitoring program 114 may be initiated to determine which of the displayed search results are pertinent to the user. The content may be updated with different content portions, displays, advertisements, etc. based on the determined interests.

A person of ordinary skill in the art will recognize that original content displayed to a user may be any media content and is not limited to webpages. For example, the content may be provided as a digital book via an e-reader. Activity monitoring program 114 may still request and receive updated content (e.g., added displays, advertisements) from a separate server computer.

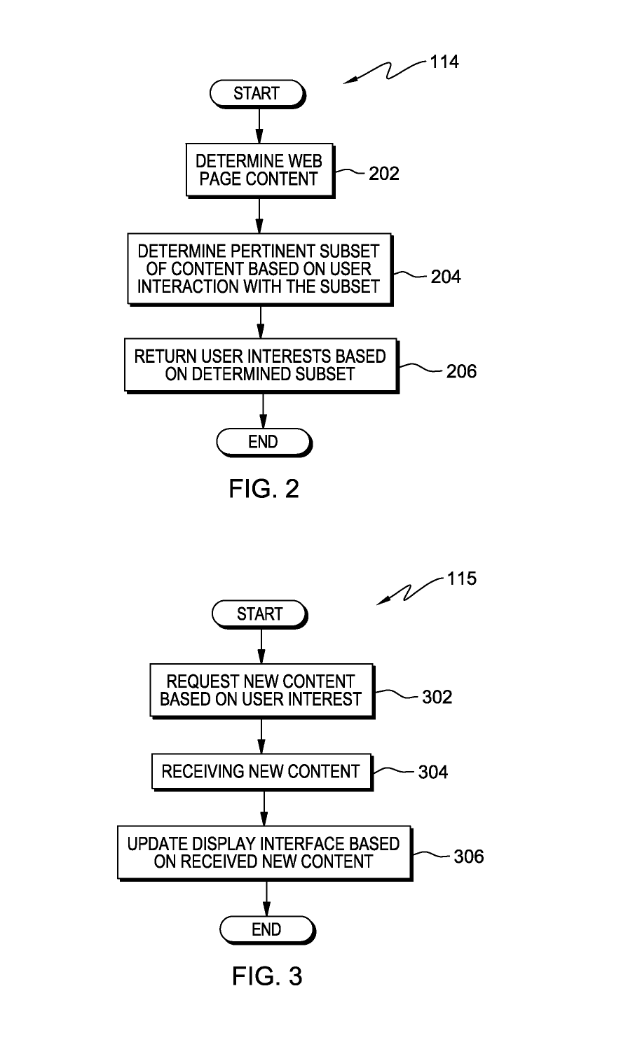

FIG. 2 is a flowchart illustrating the operational steps of activity monitoring program 114, in accordance with one embodiment of the invention.

Activity monitoring program 114 begins by determining the entire content of the webpage (step 202). Often, a webpage contains more than just text. There are typically images, tags, and metadata that provide context and descriptions for different portions of the webpage. In a preferred embodiment, activity monitoring program 114, in addition to parsing the text on a webpage, determines where these contextual indicators are on the webpage.

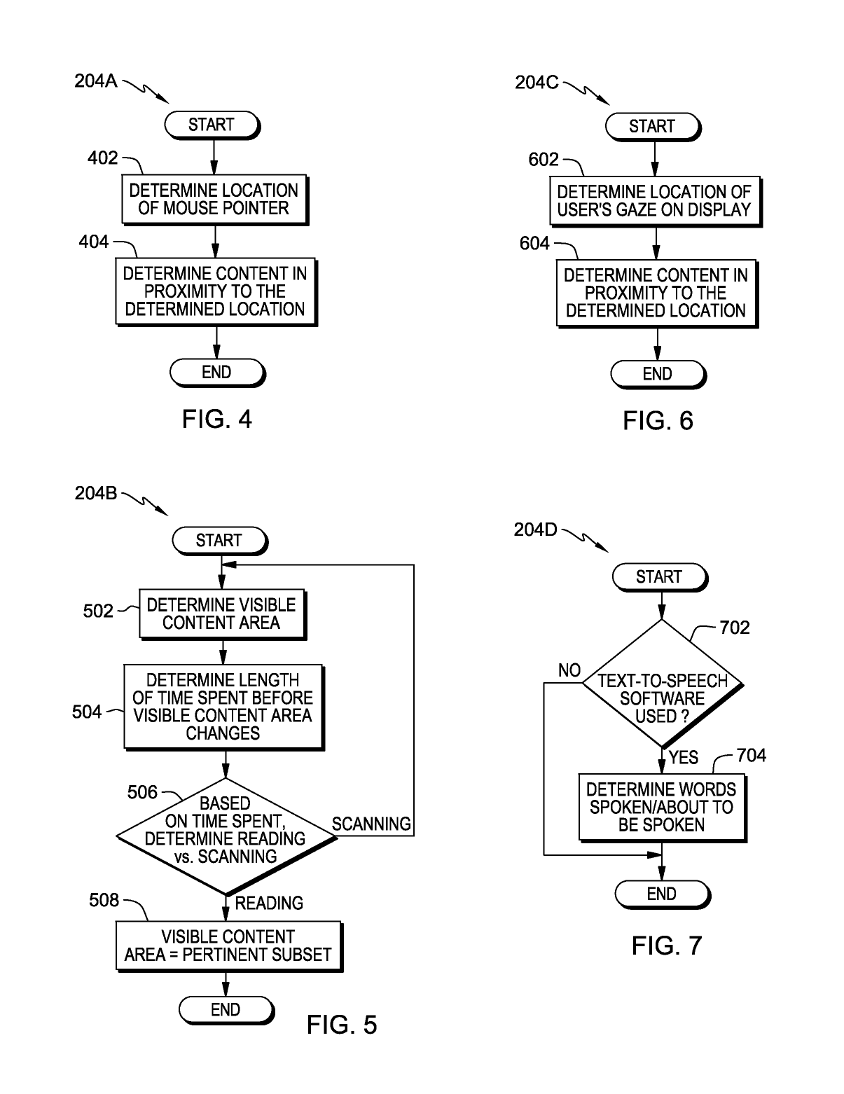

Activity monitoring program 114 then determines a pertinent subset of the entire content based on user interaction with the subset (step 204). If increased attention is given to any particular portion or subset of the content, that portion may be deemed to be of particular interest to a user. Exemplary methods for determining increased attention given to a particular portion are described in relation to FIGS. 4-7. A determined pertinent subset may then be analyzed for key words, themes, and subject matter.

In a preferred embodiment, activity monitoring program 114 returns user interests based on the determined pertinent subset (step 206) to web browser 110, which, in turn, executes updating program 115. The user interests may be composed of the aforementioned key words, themes, and subject matter.

FIG. 3 depicts the steps of a flowchart describing updating program 115, in accordance with an illustrative embodiment. Updating program 115 requests new content based on the user interests (step 302) from an external server computer, such as server computer 104 or 106. The request may include the user interests, allowing the external server computer to update various portions of the webpage and return the updates to client computer 102. Updated portions might include displays, video, audio, etc. Alternatively, the external server computer might send a separate webpage or display window to be displayed separately from the webpage currently displayed on client computer 102. Finally, the external server might merely send client computer 102 information deemed related to the user interests, such as web site links, back to client computer 102.

A user of ordinary skill in the art will recognize that determined key words, themes, and subject matter may be supplemented with other contextual information determined by activity monitoring program 114 or some other application or functionality. For example, the determined key words may be cross-referenced with past received electronic messages, concurrently received audio, content from other websites (e.g., Facebook), or combinations of the preceding to further narrow down and identify true user interests. For example, activity monitoring program 114 might determine that a subject of interest to a user is traveling to a certain location (e.g., Hawaii). This may be cross-referenced with audio received from the user expressing a desire for affordable tickets. User interests might be sent as “affordable tickets to Hawaii.” In another embodiment, this could be further cross-referenced, assuming appropriate permissions, with a website of a credit card company of the user to determine the user's current amount of frequent flyer miles.

Subsequent to requesting the new content, updating program 115 receives the new content (step 304), and updates display interface 112 based on the received new content (step 306). As described previously, the new content may be an updated webpage, a separate webpage or window, or information (e.g., addresses of related websites) deemed pertinent. When updating display interface 112, updating program 115 may replace the displayed webpage with the updated webpage, may open a new window or interface (e.g., a pop-up window), or may create a new display or banner based on received information.

An “updated” webpage may contain modified text, displays, video, and/or audio, and the modifications may be in portions of the webpage not currently in a visible portion of the display interface. In one example of updating video, based on user interests, an embedded video might be replaced with a different embedded video. In another example, a video tagged at different spots related to different content may be updated to start play at a given spot depending on the recent determined user interests (e.g., if a user was reading about an accident and immediately scrolls to the embedded video afterwards, the embedded video may begin on coverage of the accident).

FIGS. 4-7 provide exemplary means for determining a pertinent subset of the content based on user interaction with the subset, as recited in step 204 of activity monitoring program 114.

Function 204A, depicted in FIG. 4, provides a means for determining a pertinent subset based on the location of a mouse pointer. Function 204A determines the location of the mouse pointer on display interface 112 (step 402). Function 204A then determines content of the webpage in proximity with the determined location (step 404). The determined content is deemed to be the pertinent subset. In one embodiment, content of the webpage in proximity with the determined location is the nearest object or paragraph. In another embodiment, the nearest sentence is the determined content. In another embodiment, any key words or phrases within a given radius of the determined location is the determined content. Other definitions of “content proximate to the determined location” may be used in various embodiments so long as the location of the mouse pointer is determinative of the selected subset.

Function 204B, depicted in FIG. 5, provides a means for determining a pertinent subset based on time spent on displayed content. Function 204B determines a visible content area of the webpage (step 502). Often times, webpages are larger than the display interface used to show them. Scroll bars may be utilized to view unseen portions of the webpage. Function 204B assumes that any information that is not viewed by the user is not pertinent.

Function 204B then monitors the length of time the visible content area remains unchanged (step 504). The more time spent on one displayed section of a webpage, the more likely that content within the displayed section is pertinent. Function 204B uses this time to determine whether a user of the client computer 102 is reading the material (is interested in the material) or merely scanning through the material (not very interested) (decision block 506). If it is determined that the user is scanning the material or not spending a lot of time on the material, function 204B may return to step 502 to repeat the process, waiting for the user to find something that he or she is interested in. If it is determined that the user is reading the material, function 204B determines that visible content area is the pertinent subset (step 508).

Function 204C, depicted in FIG. 6, provides a means for determining a pertinent subset based on the location of a user's gaze on the display. This function, though similar to Function 204A, is a preferred embodiment as tracking a user's line of sight is more accurate than a mouse pointer at indicating what the user is looking at. Programs capable of eye tracking can detect and measure eye movements, identifying a direction of a user's gaze or line of sight (typically on a screen). The acquired data can then be recorded for subsequent use, or, in some instances, directly exploited to provide commands to a computer in active interfaces.

A basis for one implementation of eye-tracking technology involves light, typically infrared, reflected from the eye and sensed by a video camera or some other specially designed optical sensor. For example, infrared light generates corneal reflections whose locations may be connected to gaze direction. More specifically, a camera focuses on one or both eyes and records their movement as a viewer/user looks at some kind of stimulus. Most modern eye-trackers use contrast to locate the center of the pupil and use infrared and near-infrared non-collimated light to create a corneal reflection (CR). The vector between these two features can be used to compute gaze intersection with a surface after a simple calibration for an individual. Various other eye tracking techniques are known.

Function 204C determines the location of the user's gaze on display interface 112 (step 602). Function 204C then determines content of the webpage in proximity with the determined location (step 604). The determined content is deemed to be the pertinent subset. Similar to function 204A, various techniques may be employed to determine what content is deemed to be “in proximity.”

In an alternate embodiment, in addition to using eye tracking to locate a pertinent subset, facial reactions may also be used to determine if the location a user is looking at is of interest. For example, function 204C could use a web camera to additionally take in images of a user's face. Using intensity values of pixels in the image or contrast values between adjacent pixels or groups of pixels, objects, such as a mouth may be detected. While tracking the feature, if the outer edges of the mouth move up in relation to the center of the mouth (i.e., the user is smiling) when a user's gaze is at a specific location, the specific location may be deemed to be pertinent.

Function 204D, depicted in FIG. 7, provides a means for determining a pertinent subset based on words spoken or about to be spoken from the webpage via text-to-speech software. Function 204D determines if text-to-speech software is being used (decision 702), and in response, determines the words spoken and/or about to be spoken by the software (step 704). The determined words are the pertinent subset.

In another embodiment, combinations of the preceding functions may be used and cross-referenced to further narrow the pertinent content. For example, multiple pertinent subsets of webpage content may be determined, and only key words, themes, and subject matter found in multiple determined subsets may be determined to be the user interests. In one such embodiment, multiple determined subsets may be found using the same technique. For example, in a given time span, it may be determined that a user's gaze focused on three different locations for a given length of time. Three different determined subsets corresponding to the three different locations may be cross-referenced with each other to find common themes.

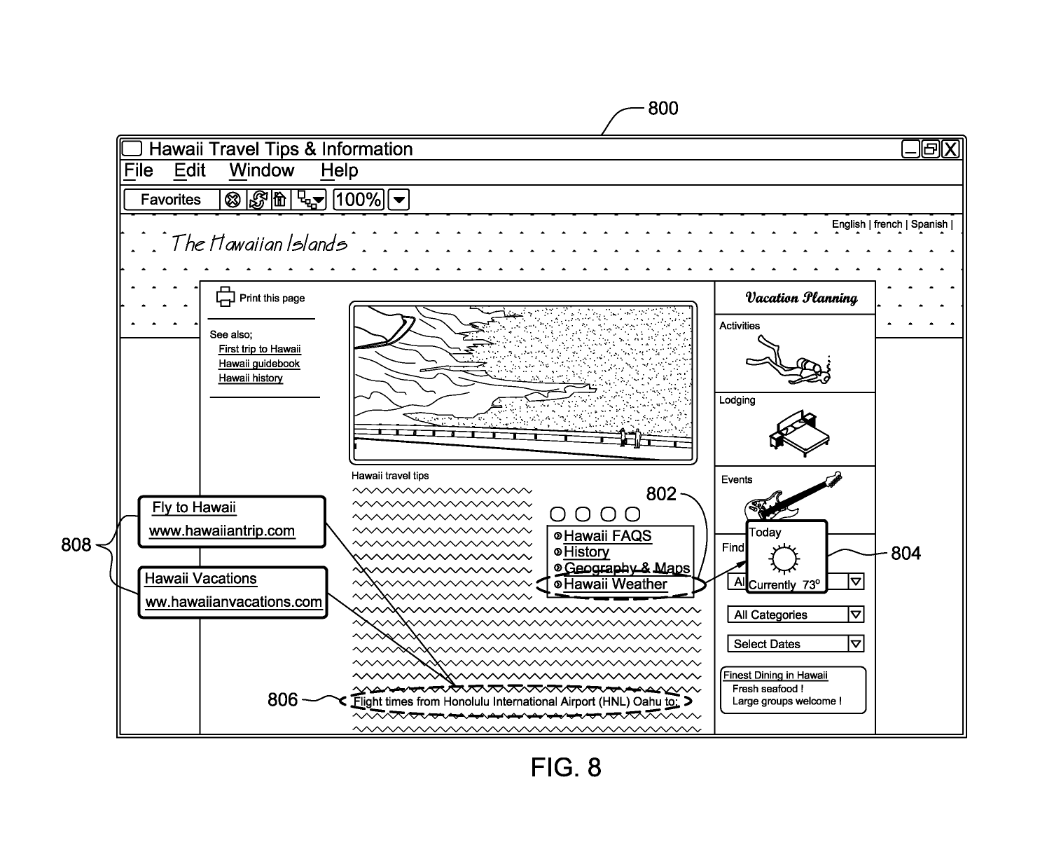

FIG. 8 depicts an exemplary webpage displayed in web browser interface 800 of a user's computer. Web browser interface 800 is one example of display interface 112. In the depicted example, if it is determined that a user is focusing on area 802, then area 802 may be selected as the pertinent subset of the webpage's content. As depicted, the area 802 contains the words “Hawaiian Weather.” In response to determining that area 802 is the pertinent subset, display 804 may be added to the webpage content giving the current temperature in Hawaii. Similarly, if area 806, discussing flights to Hawaii, is deemed to be an area of interest to the user, advertisements 808 may be displayed on the webpage showing advertisements relating to Hawaiian vacations. Display 804 and advertisements 808 may be embedded displays, floating banners, pop-up windows, or any other display medium. In another embodiment, the words “Hawaiian Weather” may actually be replaced with the words “Currently 70 degrees in Hawaii.”

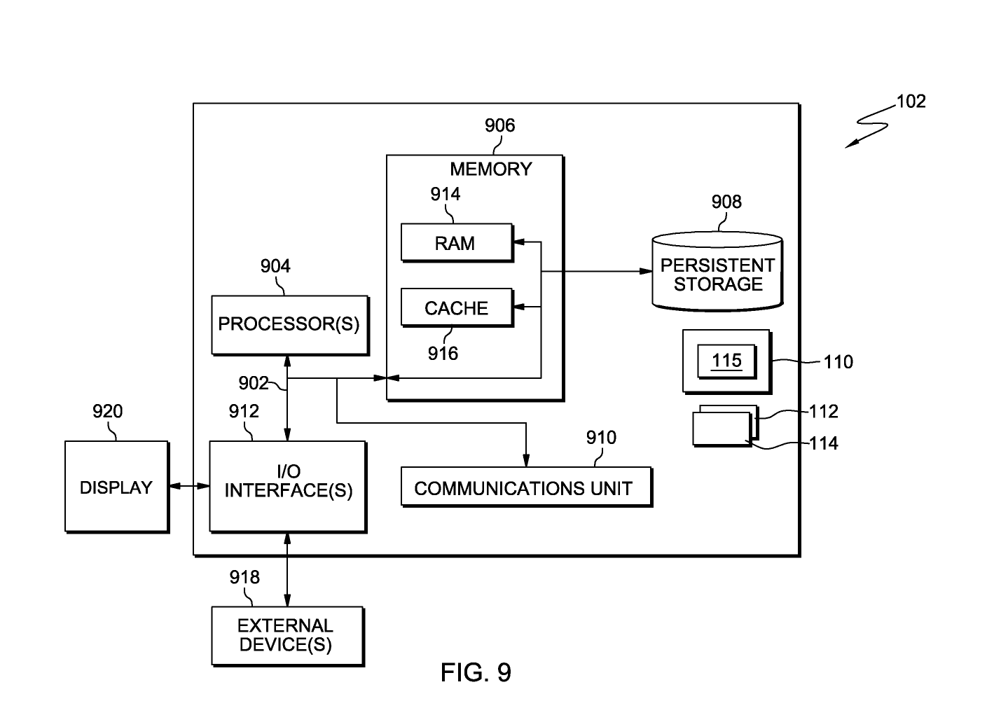

FIG. 9 depicts a block diagram of components of client computer 102 in accordance with an illustrative embodiment. It should be appreciated that FIG. 9 provides only an illustration of one implementation and does not imply any limitations with regard to the environment in which different embodiments may be implemented. Many modifications to the depicted environment may be made.

Client computer 102 includes communications fabric 902, which provides communications between processor(s) 904, memory 906, persistent storage 908, communications unit 910, and input/output (I/O) interface(s) 912.

Memory 906 and persistent storage 908 are examples of computer-readable tangible storage devices. A storage device is any piece of hardware that is capable of storing information, such as, data, program code in functional form, and/or other suitable information on a temporary basis and/or permanent basis. Memory 906 may be, for example, one or more random access memories (RAM) 914, cache memory 916, or any other suitable volatile or non-volatile storage device.

Web browser 110, display interface 112, activity monitoring program 114, and updating program 115 are stored in persistent storage 908 for execution by one or more of the respective processors 904 via one or more memories of memory 906. In the embodiment illustrated in FIG. 9, persistent storage 908 includes flash memory. Alternatively, or in addition to, persistent storage 908 may include a magnetic disk storage device of an internal hard drive, a solid state drive, a semiconductor storage device, read-only memory (ROM), EPROM, or any other computer-readable tangible storage device that is capable of storing program instructions or digital information.

The media used by persistent storage 908 may also be removable. For example, a removable hard drive may be used for persistent storage 908. Other examples include an optical or magnetic disk that is inserted into a drive for transfer onto another storage device that is also a part of persistent storage 908, or other removable storage devices such as a thumb drive or smart card.

Communications unit 910, in these examples, provides for communications with other data processing systems or devices. In these examples, communications unit 910 includes one or more network interface cards. Communications unit 910 may provide communications through the use of either or both physical and wireless communications links. In another embodiment still, client computer 102 may be devoid of communications unit 910. Web browser 110, display interface 112, activity monitoring program 114, and updating program 115 may be downloaded to persistent storage 908 through communications unit 910.

I/O interface(s) 912 allows for input and output of data with other devices that may be connected to client computer 102. For example, I/O interface 912 may provide a connection to external devices 918 such as a camera, mouse, keyboard, keypad, touch screen, and/or some other suitable input device. I/O interface(s) 912 also connects to display 920.

Display 920 provides a mechanism to display data to a user and may be, for example, a computer monitor. Alternatively, display 920 may be an incorporated display and may also function as a touch screen.

The aforementioned programs can be written in various programming languages (such as Java® or C++) including low-level, high-level, object-oriented or non object-oriented languages. Alternatively, the functions of the aforementioned programs can be implemented in whole or in part by computer circuits and other hardware (not shown).

Based on the foregoing, a method, computer system, and computer program product have been disclosed for updating content based on user activity. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. Therefore, the present invention has been disclosed by way of example and not limitation.

What is claimed is:

1. A method for dynamically updating content for presentation to a user of a computer, the method comprising the steps of:
a computer presenting content to a user;
the computer determining a relevant portion of the content based on user interaction with the relevant portion of the content; and
the computer presenting new content to the user based on the relevant portion of the content.

2. The method of claim 1, wherein the step of the computer determining the relevant portion of the content comprises:
the computer determining a location of a mouse pointer in relation to the presented content; and
the computer determining that content in proximity to the location of the mouse pointer is the relevant portion of the content.

3. The method of claim 1, wherein the step of the computer determining the relevant portion of the content comprises:
the computer determining a location of a user's gaze in relation to the presented content; and
the computer determining that content in proximity to the location of the user's gaze is the relevant portion of the content.

4. The method of claim 1, wherein the step of the computer determining the relevant portion of the content comprises:
the computer determining one or more words from the presented content for conversion to speech, and in response, determining that the one or more words are the relevant portion of the content.

5. The method of claim 1, wherein the step of the computer determining the relevant portion of the content comprises determining the relevant portion of the content based on one or both of a location of a mouse pointer and a location of a user's gaze.

6. The method of claim 1, wherein the new content is selected from the group consisting of: a webpage, an advertisement, a visual display embedded in a webpage, a visual display in a pop-up window, a video clip, an audio clip, and one or more internet addresses.

7. The method of claim 1, further comprising the steps of:
prior to the step of the computer presenting the new content:
the computer requesting new content from a server computer based on the relevant portion of the content; and
the computer receiving the new content from the server computer.

8. The method of claim 1, wherein the step of the computer presenting the new content comprises the computer presenting the new content in addition to the presented content.

9. The method of claim 1, wherein the step of the computer presenting the new content comprises the computer replacing the presented content with the new content.

10. A computer program product for dynamically updating content for presentation to a user of a computer, the computer program product comprising:
one or more computer-readable tangible storage devices and program instructions stored on at least one of the one or more storage devices, the program instructions comprising:
program instructions to present content to a user;
program instruction to determine a relevant portion of the content based on user interaction with the relevant portion of the content; and
program instructions to present new content to the user based on the relevant portion of the content.

11. The computer program product of claim 10, wherein the program instructions to determine the relevant portion of the content comprise:
program instructions to determine a location of a mouse pointer in relation to the presented content; and
program instructions to determine that content in proximity to the location of the mouse pointer is the relevant portion of the content.

12. The computer program product of claim 10, wherein the program instructions to determine the relevant portion of the content comprise:
program instructions to determine a location of a user's gaze in relation to the presented content; and
program instructions to determine that content in proximity to the location of the user's gaze is the relevant portion of the content.

13. The computer program product of claim 10, wherein the program instructions to determine the relevant portion of the content comprise:
program instructions to determine one or more words from the presented content for conversion to speech; and
program instructions to determine that the one or more words are the relevant portion of the content.

14. The computer program product of claim 10, wherein the program instructions to determine the relevant portion of the content comprise program instructions to determine the relevant portion of the content based on one or both of a location of a mouse pointer and a location of a user's gaze.

15. The computer program product of claim 10, wherein the new content is selected from the group consisting of: a webpage, an advertisement, a visual display embedded in a webpage, a visual display in a pop-up window, a video clip, an audio clip, and one or more internet addresses.

16. The computer program product of claim 10, further comprising program instructions, stored on at least one of the one or more storage devices, to:
request new content from a server computer based on the relevant portion of the content; and
receive the new content from the server computer.

17. The computer program product of claim 10, wherein the program instructions to present the new content comprises program instructions to present the new content in addition to the presented content.

18. The computer program product of claim 10, wherein the program instructions to present the new content comprises program instructions to replace the presented content with the new content.

19. A computer system for dynamically updating content for presentation to a user of a computer, the computer system comprising:
one or more processors, one or more computer-readable tangible storage devices, and program instructions stored on at least one of the one or more storage devices for execution by at least one of the one or more processors, the program instructions comprising:
program instructions to present content to a user;
program instruction to determine a relevant portion of the content based on user interaction with the relevant portion of the content; and
program instructions to present new content to the user based on the relevant portion of the content.

20. The computer system of claim 19, wherein the program instructions to determine the relevant portion of the content comprise program instructions to determine the relevant portion of the content based on one or both of a location of a mouse pointer and a location of a user's gaze.
